(19) United States
(12) Patent Application Publication
(10) Pub. No.: US 2006/0022816 A1
(43) Pub. Date: Feb. 2, 2006

(54) Home security system

(76) Inventor: Mitsuhiko Yukawa, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/909,354

(22) Filed: Aug. 3, 2004

(30) Foreign Application Priority Data
Jul. 30, 2004 (JP) 2004-224668

(51) Int. Cl. G08B 19/00; G08B 1/00; G05B 19/00

(52) U.S. Cl. 340/521; 340/531; 340/5.83

(57) ABSTRACT

The present invention provides a home security system that includes a home security controller for collecting monitor data from various crime prevention and disaster prevention sensors installed in a home via a home network and notifying the portable terminal when a state of emergency occurs. The home security controller also enables devices in the home to be operated through remote control signals via an external network. The home security system further includes a portable terminal capable of connecting to the external network and having fingerprint data inputting means mounted on the body of the portable terminal for inputting fingerprints used for authentication. The fingerprint data inputting means has an assigned ID number. The home security system further includes a security center server having fingerprint authenticating means for receiving fingerprint data from the portable terminal via the external network and authenticating the fingerprint data through comparisons with registered fingerprint data. The fingerprint authenticating means completes authentication by checking the assigned ID number of the fingerprint data inputting means and matching the received fingerprint data with fingerprint data registered in association with the ID number. The security center server allows a connection between the portable terminal and the home security controller and controls bi-directional communications between the two after the security center server has completed authentication, enabling the portable terminal to receive monitor data from and transmit remote control signals to the home security controller via the external network.

### BACKGROUND OF THE INVENTION

The present invention relates to a security system that enables a user, through a portable terminal, to monitor the state of a home whose occupants are away and to control various devices in the home from a remote location. The present invention particularly relates to a home security system capable of preventing a third party from breaking into a home network through fraudulent use of a portable terminal.

There has been a recent increase in the popularity of sophisticated cellular telephones with functions for accessing the Internet and performing broadband communications to display images and the like. For example, the home security system disclosed in Japanese unexamined patent application publication No. 2004-128821 enables a user away from home to monitor the conditions of the user's unoccupied home and perform remote control operations via the Internet or another network using a cellular telephone.

FIG. 8 is a block diagram showing this home security system. As shown in FIG. 8, a router 152 connects a control unit 151 and other devices located inside and outside a home to a LAN. In the present example, the router 152 is a switching hub or a dialup router. The router 152 includes a network address translation (NAT) or an IP Masquerade function for converting the private IP address of the control unit 151 to an assigned global IP address. A modem 153 is an analog line type modem. However, if the external data transmission channel is a digital line, a terminal adapter may be used in place of the modem. Sensor units 154, 155, and the like possess various sensor functions, including a temperature sensor, an illumination sensor, a human sensor, sensors for detecting the opening and closing of windows, and a sensor for detecting when a doorbell is pressed. A camera 156 is a video camera connected to the router 152 via the LAN.

The control unit 151 monitors the status of the sensors and notifies a cellular telephone 158 via an internet 157 when an abnormality has occurred. The cellular telephone 158 is notified of an abnormality through e-mail in which are written details of the abnormality and the global IP address of the control unit, which is a URL for accessing the control unit 151. When the cellular telephone 158 receives e-mail containing such an abnormality notification, the user of the cellular telephone 158 may perform input operations in the cellular telephone 158 to display an operation window on a Web page located at the URL in order to operate the camera or the like. Upon receiving such input operations (commands) from the cellular telephone 158 via the Web page, the control unit 151 sets the private IP address of the sensor unit (camera) required for operating the sensor device (camera or the like) and transmits the command to the camera 156 via the LAN. In this way, the user may perform remote control operations in an unoccupied home. For example, the camera 156 may perform pan, tilt, or other operations based on the command. If the target device is a home electronics device, the device may be switched on or off by transmitting an infrared remote control signal according to the command.

However, the conventional home security system described above does not perform a rigorous authentication procedure to determine whether the user of the cellular telephone is the correct user. Therefore, it is difficult to block impersonations or interceptions by a third party. If the system does not detect impersonation by a third party with criminal intent and allows access to this person, the system is actually providing details of the interior of the home including the whereabouts of alarms to the criminal via the internet, even instructing the criminal how to deactivate the alarms, thereby inviting a disastrous situation.

Further, since the system connects to the internet with a modem or a terminal adapter, the correspondence between the global IP address and the private IP addresses for each device changes on each connection, making access from an external device more complicated.

Although some wireless LANs are currently in use, wired LANs are still the most commonly used system. The layout of cables in such wired LANs can be an eyesore and an obstruction and may lead to problems in the construction of a home network.

Further, the security of such a system is low because encryption processes for data transferred over the internet are not sufficiently secure.

In view of the foregoing, it is an object of the present invention to provide a home security system capable of preventing nearly all attempts to break into the network by an uncontracted third party through fraudulent use of the authorizing means. Such intrusions are prevented by introducing a fingerprint checking system for checking the fingerprints of a user using a portable terminal such as a cellular telephone, and a sophisticated authentication procedure using a home security stick provided with a unique ID. The system is configured to support an always-on broadband connection, facilitating operations through a fixed IP address. In this system, a home network is constructed of a wireless LAN, clearing out all cables from sight and enabling dialogue between the in-home devices. By introducing an encryption system capable of assuring the security of data transferred from the in-home devices to the portable device on an external network, the home security system can provide a sophisticated home security service.

### SUMMARY OF THE INVENTION

These and other objects are attained by a home security system for monitoring conditions in a home through surveillance functions installed therein and for alerting the user of the system when an abnormality has been detected in the home. The system includes monitoring means possessing various crime prevention and disaster prevention sensors installed in the home and connected to a home network; a home security controller for collecting monitor data from said monitoring means via the home network and determining when a state of emergency occurs, said home security controller possessing a remote control function that allows devices in the home to be operated through a remote control signal via an external network; a portable terminal capable of connecting to the external network and having fingerprint data inputting means mounted on a body thereof for inputting fingerprint data used for authentication, said fingerprint data inputting means having an assigned ID number; and a security center server having fingerprint authenticating means for receiving fingerprint data from said portable terminal via the external network and authenticating the fingerprint data through comparisons with registered fingerprint data. Said fingerprint authenticating means completes authentication by checking the assigned ID number of said fingerprint data inputting means and matching the received fingerprint data with fingerprint data registered in association with the ID number. Said security center server allows a connection between said portable terminal and said home security controller and controls bi-directional communications between the two after said security center server has completed authentication, enabling said portable terminal to receive monitor data from and transmit remote control signals to said home security controller via the external network. Said home security controller notifies said portable terminal by an emergency communication when a state of emergency occurs.

Further, said fingerprint data inputting means creates and outputs a template indicating characteristic areas of fingerprint data acquired in a scan by a fingerprint scanning sensor that has been irreversibly converted to digital data.

Further, said fingerprint data inputting means has a unique ID number, is formed in a stick-like shape, and connects to an external connector of said portable terminal in order to transfer data. The fingerprint data inputting means is either a basic type having only a function for scanning the fingerprint data, an authentication type also provided with a circuit on an IC chip for authenticating said fingerprint data, or a built-in type comprising a fingerprint sampling sensor built into said portable terminal itself.

Further, said home security controller includes a broadband modem supporting a type of broadband from among asymmetric digital subscriber line (ADSL), cable television (CATV), and fiber to the home (FTTH) for performing data communications; a firewall for managing ports and encoding and decoding data to preserve security on the internet; a server having transmission and reception programs for exchanging data used to control a Web camera and various sensors between said security center server, a router function for connecting a personal computer to the internet, and the like; a sensor controller for controlling various sensors; a TCP/IP controller for controlling the personal computer connected via TCP/IP or a web camera; a CTI controller for managing telephone calls between said portable terminal and the like; and a power unit for supplying power from a power source and serving as a battery backup system during power outages.

Further, the crime prevention sensors managed by said home security controller comprise a combination of at least one of thermal sensors for detecting the intrusion of suspicious individuals, glass-breaking sensors, magnetic window switches for detecting the opening and closing of windows, night-vision cameras, and a keypad locking mechanism. The disaster prevention sensors managed by said home security controller comprise a combination of at least one of fire alarms, flood prevention transmitters, pendant transmitters, and cameras with a motion-activated light.

Further, said home security controller assigns an address to each of the sensors and in-home devices and controls these sensors and devices through a home network configured of a wireless LAN or the like.

Further, said home security controller has various remote operating functions for locking the system through said keypad locking mechanism, performing camera surveillance, and the like through remote control signals issued from said portable terminal.

Further, internet communications between said security center server and said portable terminal or between said security center server and said home security controller and the indoor wireless LAN possessed by said home security controller employ a DETPT (Dual Encryption Technology for Packet Telecommunication) for encrypting the order of each data packet according to a special key and modifying the position of data in each packet.

Further, said emergency communication performed by said home security controller comprises an e-mail communication and a two-way telephone communication.

The present invention has the following effects. First, the home security system according to the present invention is capable of preventing nearly all attempts to break into the network by an uncontracted third party through fraudulent use of the authorizing means. Such intrusions are prevented by introducing a fingerprint checking system for checking the fingerprints of a user using a portable terminal such as a cellular telephone, and a sophisticated authentication procedure using a home security stick provided with a unique ID.

Further, the system is configured to support an always-on broadband connection, facilitating operations through a fixed IP address. In this system, a home network is constructed of a wireless LAN, clearing out all cables from sight and enabling dialogue between the in-home devices.

Further, the home security system can provide a sophisticated home security service by introducing an encryption system capable of assuring the security of data transferred from the in-home devices to the portable device on an external network.

### BRIEF DESCRIPTION OF THE DRAWINGS

The above and other objects, features, and advantages of the invention will become more apparent from reading the following description of the preferred embodiment taken in connection with the accompanying drawings in which:

FIG. 1 is a block diagram showing a home security system according to the present invention;

FIG. 2 is a is an explanatory diagram illustrating fingerprint authorization performed by the system in FIG. 1;

FIG. 3 is a block diagram showing a home security controller of FIG. 1;

FIG. 4 is an explanatory diagram illustrating an encryption method according to the present invention;

FIG. 5 is a flowchart showing a process for registering a fingerprint scanned by the home security stick of FIG. 1;

FIG. 6 is a block diagram showing the structure of a Web camera of FIG. 1;

FIG. 7 shows remote control screens displayed on a cellular telephone of FIG. 1; and

FIG. 8 is a block diagram showing a conventional home security system.

### DESCRIPTION OF THE NUMBERED PARTS

1 home security system
2 home
3 home security controller
4 cellular telephone
5 home security stick
6 security center server
7 internet
8 thermal sensor
9 night-vision camera
10 glass-breaking sensor
11 magnetic switch
12 flood prevention transmitter
13 camera with a motion-activated light
14 fire alarm
15 pendant transmitter
16 keypad locking mechanism
20 fingerprint image
21 process for converting characteristic points into encrypted digital data
22 template
23 ridges
24 valleys
25 endpoints
26 bifurcations
30 modem
31 firewall
32 server
33 TCP/IP controller
34 sensor controller
35 CTI controller
50 optical lens
51 CMOS
52 data compressor
53 camera controller
54 storage unit
55 display
56 position-driving motor
57 protocol stack
58 internet interface
59 TCP/IP protocol storage unit
60 MAC address storage unit
61 wireless LAN card
70 internet communication unit
80 surveillance control screen
81 Image of emergency warning
82 Image of an appointment

### DESCRIPTION OF THE PREFERRED EMBODIMENTS

Next, a home security system according to a preferred embodiment of the present invention will be described while referring to the accompanying drawings.

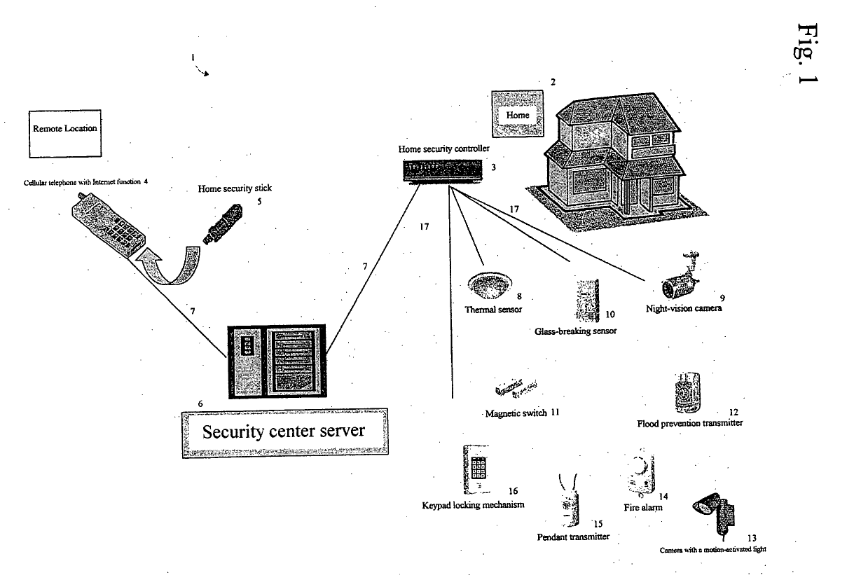

FIG. 1 is a block diagram showing a home security system 1 according to the preferred embodiment. As shown in FIG. 1, the home security system 1 includes an internet 7, a home security controller 3 installed in a home 2 and connected to the internet 7 through a broadband connection, a cellular telephone 4 that can also connect to the internet 7, and a security center server 6 provided on the internet 7 for managing the entire home security system.

The home 2 may be a residential home, an office, or a similar space. The home security controller 3 is installed in the home 2 and includes various functions such as an internet firewall, gateway, and wireless LAN router compatible with asymmetric digital subscriber line (ADSL), cable television (CATV), fiber to the home (FTTH), or other types of broadband internet.

A home security stick 5 mounts on the cellular telephone 4 for checking the user's fingerprints. The security center server 6 is an authentication management server for authenticating fingerprints received from the cellular telephone 4 via the internet 7 and allowing the cellular telephone 4 access to the home security controller 3 when authentication is successful.

A wireless LAN network is constructed in the home 2 using the home security controller 3. Through wireless LAN connections 17, the home security controller 3 is connected to various crime prevention sensors, including a thermal sensor 8 for detecting body heat and the like, a night-vision camera 9 such as an infrared camera, a glass-breaking sensor 10 configured of conductive foil or the like affixed to glass, a magnetic switch 11 for detecting the opening and closing of a window, and a keypad locking mechanism 16. Each sensor employs a wireless LAN card or the like with a built-in antenna, such as a device mounted in a PC card slot for sensors. The home security controller 3 is also connected to various disaster prevention sensors, including a flood prevention transmitter 12, a camera with a motion-activated light 13 such as a CMOS or CCD camera, a fire alarm 14, and a pendant transmitter 15 using wireless LAN cards or the like that communicate by a wireless protocol such as Carrier Sense Multiple Access/Collision Detection (CSMA/CD). Next, the home security stick 5 used for fingerprint checking and the home security controller 3 will be described in greater detail.

Rather than the conventional method of authenticating a user through a personal ID and password, the system of the preferred embodiment employs an authentication method based on the user's fingerprint. In this method, the home security stick 5 shown in FIG. 1 is mounted on the external connector of the cellular telephone 4. A fingerprint scanner built into the home security stick 5 is well known in the art and is commonly used in various fingerprint authenticating devices, such as a Windows (registered trademark)-compatible fingerprint detecting system that detects temperature differences when swept over a finger. This system has a false rejection rate (FFR) of 1/1,000 or less and a false acceptance rate (FAR) of 1/10,000 or less. A non-erasable unique ID is encrypted and written in each home security stick 5.

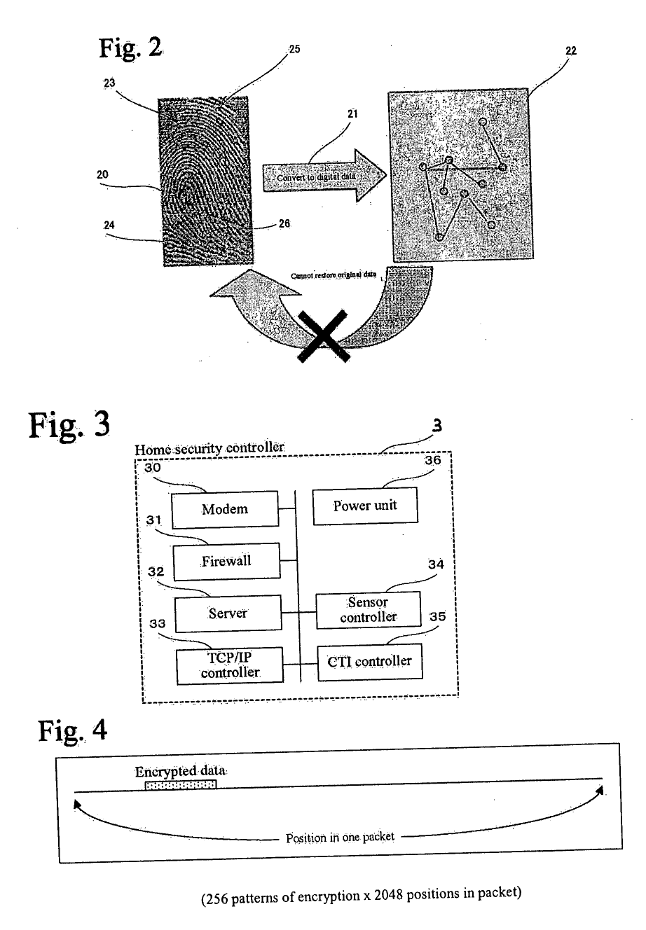

This fingerprint detection system uses an authentication algorithm well known in the art called a Minutia extraction algorithm for extracting characteristic points in a fingerprint. FIG. 2 is an explanatory diagram illustrating this method of fingerprint detection. According to this method, a fingerprint image 20 is scanned, and characteristic points of the fingerprint image 20 are extracted. These characteristic points include ridges 23, valleys 24, endpoints 25, and bifurcations 26. Subsequently, a process 21 is performed to convert the characteristic points into encrypted digital data, creating a template 22. The template 22 is transferred to and recorded on the security center server 6, which has an authentication server function. Unlike fingerprint images and image processing (pattern matching) data, the original fingerprint image cannot be restored from the template 22. This irreversible quality is advantageous for security purposes.

While the home security stick 5 in the system of the preferred embodiment is equipped only with a fingerprint scanning sensor, the fingerprint authentication being implemented by the authentication server implemented in the security center server 6, the home security stick 5 may also be equipped with an IC memory for registering fingerprints so that the entire fingerprint authentication process may be completed by the home security stick 5 itself. This latter system is completely secure since fingerprint data is not registered externally. However, the chips and power supply required for the IC memory and the authentication circuit make it difficult to manufacture the device in a compact size and at a low cost. Further, while some cellular telephones are provided with a built-in fingerprint authentication circuit themselves, this scenario would require the use of a special cellular telephone. The stick may also be connected using a mini USB connector designed for cellular telephones, or fingerprint data may be transferred wirelessly using Bluetooth.

Next, the home security controller 3 will be described in greater detail. FIG. 3 is a block diagram showing the home security controller 3. As shown in FIG. 3, the home security controller 3 includes a broadband modem 30 supporting broadband ADSL, CATV, and FTTH; a firewall 31 that performs such functions as port management, filtering, and encoding/decoding of wireless LAN/internet formats for maintaining security between the wireless LAN and the external internet; and a server 32. The server 32 includes a web server that manages the connection with the internet 7 and supports ADSL, CATV, and FTTH broadband for a constant connection. The web server has a router function for converting global IP addresses and private IP addresses using IP Masquerade, VHCP, or the like, but cannot change the connection from an always-on connection. Therefore, unless intentionally modified, the server 32 can be treated as a fixed IP address, eliminating the confusion that results when the private IP address is changed each time the server connects to the internet, as in a dialup connection. The server 32 also includes a mail server function, and a wireless LAN router function for configuring a wireless LAN with the web cameras 9 and 13 and the other sensors. The in-home wireless LAN is configured of wireless LAN cards used in the various sensors, personal computer, and the like, and a broadband wireless LAN router.

The home security controller 3 also includes a TCP/IP controller 33 for controlling the web cameras and the like through an internet connection and wireless LAN connection; and a sensor controller 34 for controlling operations of the sensors. For example, the glass-breaking sensor 10 detects breakage in a plurality of conductive foils by detecting the resistance, voltage, and current values in the foils. The sensor controller 34 controls the supply of electricity to the glass-breaking sensor 10 for detecting glass breakage. The home security controller 3 also includes a computer telephony integration (CTI) controller 35 for controlling communications through a telephone line that are performed in addition to e-mail communications in an emergency situation; and a power unit 36 that includes functions for supplying power from a power source and serving as a battery backup during a power outage. The home security controller 3 is designed as a stationary device with a square shape or the like and is purchased by the user along with the home security stick 5. The user also pays usage fees or the like for the service provided by the security center server 6.

As described above, the home security controller 3 includes a broadband modem function supporting ADSL, CATV, and FTTH, a router function for a wireless LAN, a firewall function, and a sensor detection function. The home security controller 3 is used not only for crime and disaster surveillance, but also as a gateway to the home network configured of the wireless LAN.

In addition to functioning as an authentication server for the home security controller 3, the security center server 6 may include operations for enhancing safety in order to construct a failsafe system. For example, the security center server 6 may establish sessions corresponding to the sensor detecting function of the home security controller 3, sharing the monitoring duties of the home security controller 3 for monitoring the sensors as a redundant system and storing the results as history data.

In addition to the home security controller 3 issuing e-mail and telephone calls to the user when an emergency situation arises, the security center server 6 may also undertake security duties involving enforcing or sharing such duties as dispatching a security guard for patrol and placing emergency calls to the fire department and police department. If the security center server 6 does not have an actual policing system in place for maintaining security, the system can be configured to work together with another security company for dispatching security guards.

Security is ensured by encrypting all data transferred via the internet 7 or the wireless LAN. The present invention employs a recent encryption technology called dual encryption technology for packet telecommunication (DETPT).

In conventional encryption techniques, the order of data is encrypted according to a special key each time a connection is made, and the data is subsequently extracted on the receiving end. DETPT not only modifies the order of the data on each connection, but also the position in which the data is placed in the packet, as illustrated in FIG. 4. Hence, security can be maintained since it is nearly impossible for a third party to extract data within the several tens of seconds allotted for authentication.

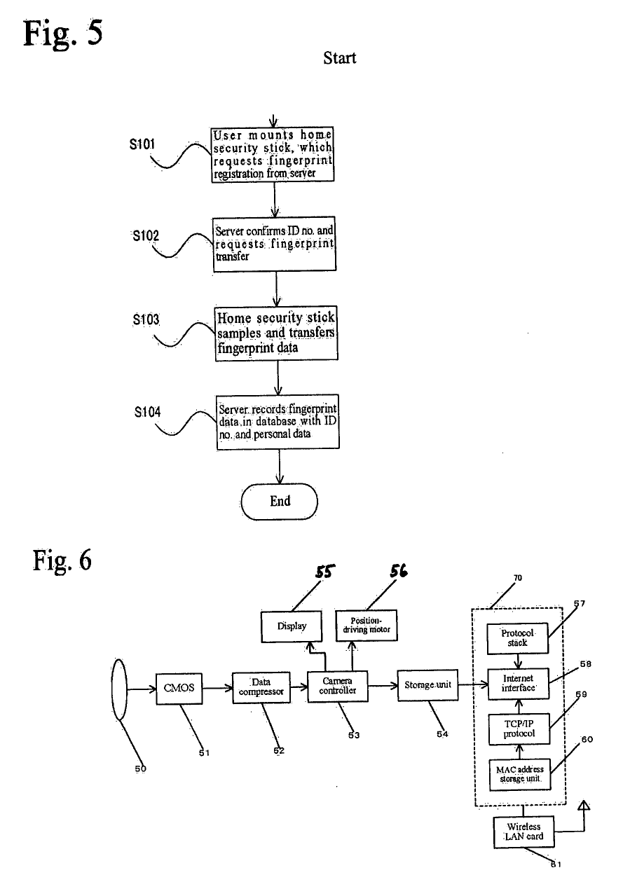

Next, the overall authentication process will be described. First, the process for registering a user's fingerprint will be described with reference to the flowchart in FIG. 5.

When the user purchases the home security stick 5 and first mounts the home security stick 5 on the cellular telephone 4, the home security stick 5 automatically calls the address of the security center server 6 and issues a request for fingerprint registration (S101). Upon receiving this registration request, the security center server 6 requests that the user input a fingerprint, after first reading the unique ID of the home security stick 5 and confirming such personal data as the name of the user who purchased the home security stick 5 (S102).

Upon receiving this request to transfer a fingerprint, the user is prompted to press a finger onto the sensor portion of the home security stick 5 to be scanned. An image of the user's fingerprint is taken a number of times (three, for example) consecutively. Data for the characteristic points of the fingerprint is extracted and encrypted to create the template 22, as shown in FIG. 2, which is then transferred to the security center server 6 (S103). The security center server 6 functioning as a fingerprint authentication server records the template 22 linked with the unique ID of the home security stick 5 and personal data on the user in an authentication database (S104). The process for registering the user's fingerprint ends at this point, after which the security center server 6 functions as a fingerprint authentication server.

With the system shown in FIG. 1, if the user is subsequently away from home and wishes to remotely monitor the conditions at home via the internet 7, the user mounts the home security stick 5 on the cellular telephone 4 and accesses the server 32 of the home security controller 3. At this time, the home security controller 3 issues a request for authentication to the security center server 6, which is functioning as a fingerprint authentication server. The security center server 6 checks the user's fingerprint against the registered template 22 in the authentication database and returns the results of this authentication to the home security controller 3. The home security controller 3 establishes a connection with the cellular telephone 4 if the results of authentication are positive, or breaks off communications with the cellular telephone 4 if the fingerprint does not match the template 22.

In the preferred embodiment, the home security controller 3 and the security center server 6 may be in an always-connected state for performing authentication, with the home security controller 3 serving as a web server and the security center server 6 operating as a fingerprint authentication server. For example, an authentication session may be established using a dedicated line, or authentication service procedures may be performed using a server-side program such as active server pages (ASP).

In the preferred embodiment, user authentication is performed based on a combination of the unique ID of the home security stick 5 and fingerprint matching. Accordingly, the system according to the preferred embodiment can prevent nearly all accesses to the network by unauthorized individuals, whereas user authentication through IDs and passwords is much more susceptible to impersonations, data interceptions, and other risks.

Next, an example of accessing the home security controller 3 from the cellular telephone 4 after the aforementioned authentication has been completed will be described. In this example, the cellular telephone 4 gains access to monitor the interior of the home 2 through the camera with a motion-activated light 13.

FIG. 6 is a block diagram showing the structure of the Web camera. The Web camera includes an optical lens 50, a CMOS (or CCD) 51 for converting an image obtained through the optical lens 50 by photoelectric transfer, and a data compressor 52 for compressing the converted data according to the MPEG format or the like. A display 55 displays the current view taken by the camera. A position-driving motor 56 adjusts the pan, tilt angle, and the like of the camera based on control signals received from a camera controller (CPU) 53. A data storage unit 54 receives a monitor image request signal from an internet communication unit 70 and outputs the signal to the camera controller (CPU) 53. The storage unit 54 also outputs a monitor image inputted via the camera controller (CPU) 53 to the internet communication unit 70. The internet communication unit 70 includes a protocol stack 57 for storing protocols used for data communications, a TCP/IP protocol storage unit 59 for storing a TCP/IP protocol for the internet and LAN, an internet interface 58, a MAC address storage unit 60, and a wireless LAN card 61. The internet communication unit 70 communicates with the cellular telephone 4 via a router in the home security controller 3 and the internet 7.

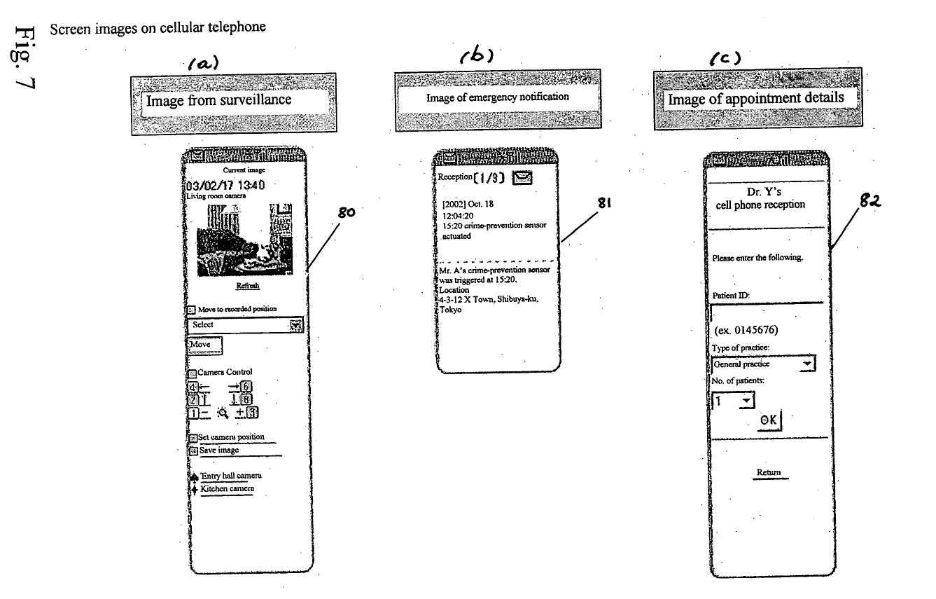

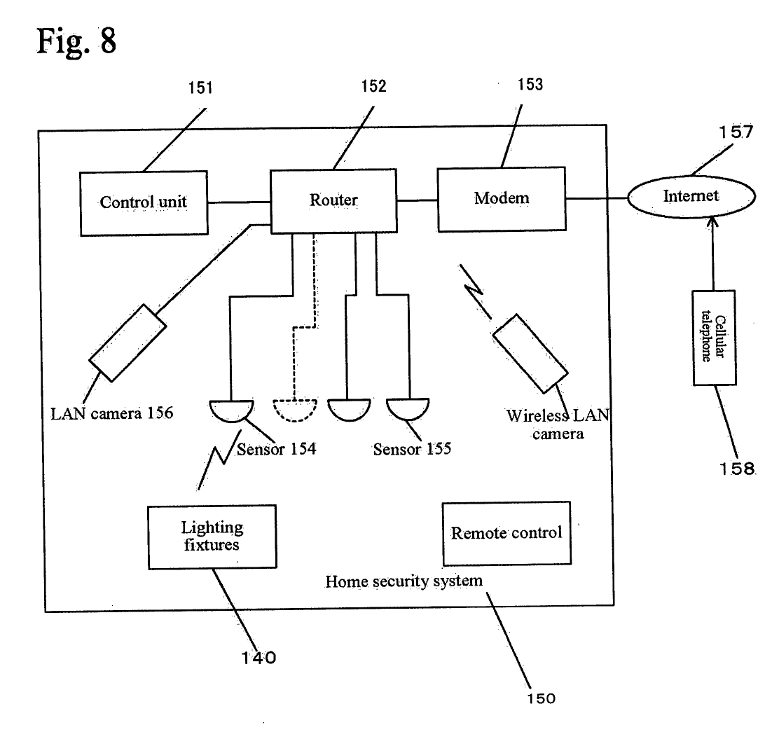

When using the cellular telephone 4 to access a Web camera in the home such as the camera with a motion-activated light 13 shown in FIG. 6, the cellular telephone 4 connects to the security center server 6, receives authentication, and accesses the home security controller 3 via the internet 7. Next, the cellular telephone 4 transmits a connection request signal specifying the fixed IP address, camera name and number, and the like of the camera with a motion-activated light 13, connects to the camera with a motion-activated light 13 via the internet, and requests a monitor image or the like. The storage unit 54 in the camera with a motion-activated light 13 outputs the requested monitor image, which is transferred to the cellular telephone 4. The monitor image, which may be a current image from a camera in the living room, for example, is displayed in a surveillance control screen 80 provided on the cellular telephone 4, showing a current view of the living room, as illustrated in FIG. 7(a).

If the user wishes to switch the image shown on the surveillance control screen 80 from the living room to a camera at another location, such as an entry hall or a kitchen, the user clicks on a “Switch” button and selects “Kitchen,” for example, to replace the monitor image of the living room with an image from a kitchen camera (not shown).

The user can also remotely control the position and brightness of the kitchen camera by inputting values for the left/right pan angle, up/down tilt angle, and plus/minus brightness adjustment under “Camera Control.” The monitor image can be stored by pressing the “Save” button.

While a procedure for remotely controlling the camera with a motion-activated light 13 was described above as an example, this remote control is not limited to the Web camera, but can be used in a similar procedure for other sensors or devices.

If the home security controller 3 determines that the crime prevention and disaster prevention systems that monitor the state of the home based on output values from the in-home sensors have detected a state of emergency, then the home security controller 3 transmits an emergency warning via e-mail to the cellular telephone 4, as shown in FIG. 7(b). Since there is a chance that the e-mail message may be delayed, the CTI controller 35 of the home security controller 3 simultaneously issues a two-way alert via telephone.

Upon receiving these alerts, the user calls the security company, fire department, police department, or the like as needed. If the user has engaged in a security contract with this system, the security center server 6 assumes duties for providing security.

Further, the home network is configured of a wireless LAN in the system according to the present invention, making it possible to implement various in-home control by facilitating communication between devices in the home, and switching on and off the power to such electronic devices as lights, refrigerators, air conditioning, televisions, hot-water heaters, and the like.

The security center server 6 can also enable the user to make various appointments via the internet, as shown in FIG. 7(c). In addition to functions for monitoring crime and disasters, the security center server 6 can provide such services as crime news, ring tones, screensavers, and various reservations and bookings.

What is claimed is:

1. A home security system for monitoring conditions in a home through surveillance functions installed therein and for alerting the user of the system when an abnormality has been detected in the home, the system comprising:
monitoring means possessing various crime prevention and disaster prevention sensors installed in the home and connected to a home network;
a home security controller for collecting monitor data from said monitoring means via the home network and determining when a state of emergency occurs, said home security controller possessing a remote control function that allows devices in the home to be operated through a remote control signal via an external network;
a portable terminal capable of connecting to the external network and having fingerprint data inputting means mounted on a body thereof for inputting fingerprint data used for authentication, said fingerprint data inputting means having an assigned ID number; and
a security center server having fingerprint authenticating means for receiving fingerprint data from said portable terminal via the external network and authenticating the fingerprint data through comparisons with registered fingerprint data;
wherein said fingerprint authenticating means completes authentication by checking the assigned ID number of said fingerprint data inputting means and matching the received fingerprint data with fingerprint data registered in association with the ID number;
said security center server allows a connection between said portable terminal and said home security controller and controls bi-directional communications between the two after said security center server has completed authentication, enabling said portable terminal to receive monitor data from and transmit remote control signals to said home security controller via the external network; and
said home security controller notifies said portable terminal by an emergency communication when a state of emergency occurs.

2. A home security system according to claim 1, wherein said fingerprint data inputting means creates and outputs a template indicating characteristic areas of fingerprint data acquired in a scan by a fingerprint scanning sensor that has been irreversibly converted to digital data.

3. A home security system according to claim 1, wherein said fingerprint data inputting means has a unique ID number, is formed in a stick-like shape, and connects to an external connector of said portable terminal in order to transfer data; and is either a basic type having only a function for scanning the fingerprint data, an authentication type also provided with a circuit on an IC chip for authenticating said fingerprint data, or a built-in type comprising a fingerprint sampling sensor built into said portable terminal itself.

4. A home security system according to claim 1, wherein said home security controller comprises:
a broadband modem supporting a type of broadband from among asymmetric digital subscriber line (ADSL), cable television (CATV), and fiber to the home (FTTH) for performing data communications;
a firewall for managing ports and encoding and decoding data to preserve security on the internet;
a server having transmission and reception programs for exchanging data used to control a Web camera and various sensors between said security center server, a router function for connecting a personal computer to the internet, and the like;
a sensor controller for controlling various sensors;
a TCP/IP controller for controlling the personal computer connected via TCP/IP or a web camera;
a CTI controller for managing telephone calls between said portable terminal and the like; and
a power unit for supplying power from a power source and serving as a battery backup system during power outages.

5. A home security system according to claim 1, wherein the crime prevention sensors managed by said home security controller comprise a combination of at least one of thermal sensors for detecting the intrusion of suspicious individuals, glass-breaking sensors, magnetic window switches for detecting the opening and closing of windows, night-vision cameras, and a keypad locking mechanism; and the disaster prevention sensors managed by said home security controller comprise a combination of at least one of fire alarms, flood prevention transmitters, pendant transmitters, and cameras with a motion-activated light.

6. A home security system according to claim 1, wherein said home security controller assigns an address to each of the sensors and in-home devices and controls these sensors and devices through a home network configured of a wireless LAN or the like.

7. A home security system according to claim 6, wherein said home security controller has various remote operating functions for locking the system through said keypad locking mechanism, performing camera surveillance, and the like through remote control signals issued from said portable terminal.

8. A home security system according to claim 1, wherein internet communications between said security center server and said portable terminal or between said security center server and said home security controller and the indoor wireless LAN possessed by said home security controller employ a DETPT (Dual Encryption Technology for Packet Telecommunication) for encrypting the order of each data packet according to a special key and modifying the position of data in each packet.

9. A home security system according to claim 1, wherein said emergency communication performed by said home security controller comprises an e-mail communication and a two-way telephone communication.
